(19) United States
(12) Patent Application Publication
(10) Pub. No.: US 2007/0082249 A1
(43) Pub. Date: Apr. 12, 2007

(54) Two-sided fuel flow board structure

(76) Inventors: Hsi-Ming Shu, Taipei (TW); Yean-Der Kuan, Taipei (TW); Tsang-Ming Chang, Taipei (TW); Wei-Li Huang, Taipei (TW); Feng-Yi Deng, Taipei (TW)

Correspondence Address: G. LINK Co.,LTD, 3550 Bell Road, MINOOKA, IL, 60447, US

(21) Appl. No.: 11/245,003

(22) Filed: Oct. 7, 2005

(51) Int. Cl. H01M 2/02; H01M 2/00

(52) U.S. Cl. 429/34

(57) ABSTRACT

A two-sided fuel flow board structure is disclosed, which includes a plate, at least one top concave portion, at least one bottom concave potion, at least one injection flow channel, and at least one exhaust flow channel. The top and the bottom concave portions separately formed on an upper surface and a lower surface of the plate, and each of them is disposed corresponding to each membrane electrode assembly of a fuel cell board. The injection flow channels are formed on the upper surface and the lower surface of the plate, and connected to each of the top and the bottom concave portions, respectively. The exhaust flow channels are formed on the upper surface and the lower surface of the plate, and separately connected to each of the top and the bottom concave portions.

### FIELD OF THE INVENTION

The present invention relates to a structure of a fuel flow board in a fuel cell, and more particularly, to a two-sided fuel flow board having flow field structures formed on its two-sided surfaces, on which fuel cell boards are separately stuck.

### BACKGROUND OF THE INVENTION

Conventionally, flow field structures like trenches are deployed merely on a single side of a fuel flow board in a fuel cell device. Hence, membrane electrode assemblies (MEAs) of a fuel cell board can be stuck only on the single side of the conventional fuel flow board. If such way to combine fuel flow board and fuel cell board is applied to the fuel cell device with flat and large areas, the area of the fuel flow board should be at least as large as the fuel cell board in order to supply fuel for each MEA. It is thus apparent that conventional fuel flow board is not suitable for use in small-sized fuel cell device.

Therefore, an improved two-sided fuel flow board structure is needed to overcome the aforesaid disadvantages.

### SUMMARY OF THE INVENTION

The primary object of the invention is to provide a two-sided fuel flow board structure having flow field structures formed on the two-sided surfaces of the fuel flow board.

Another object of the invention is to provide a two-sided fuel flow board structure, which reduces the whole volume of a fuel cell device.

In accordance with the objects of the invention, a two-sided fuel flow board structure is provided. The structure includes a plate, top concave portions and bottom concave portions, wherein the top and bottom concave portions are separately formed on an upper surface and a lower surface of the plate, and are disposed corresponding to each membrane electrode assembly of a fuel cell board.

### BRIEF DESCRIPTION OF THE DRAWINGS

The foregoing aspects, as well as many of the attendant advantages and features of this invention will become more apparent with reference to the following detailed description, when taken in conjunction with the accompanying drawings, wherein:

FIG. 1 is an exploded diagram of a fuel cell device having a two-sided fuel flow board according to one embodiment of the invention;

FIG. 2 shows the cross-section view of FIG. 1;

FIG. 3A illustrates a view of the upper surface of a two-sided fuel flow board according to one embodiment of the invention; and

FIG. 3B illustrates a view of the lower surface of a two-sided fuel flow board according to one embodiment of the invention.

### DETAILED DESCRIPTION OF THE INVENTION

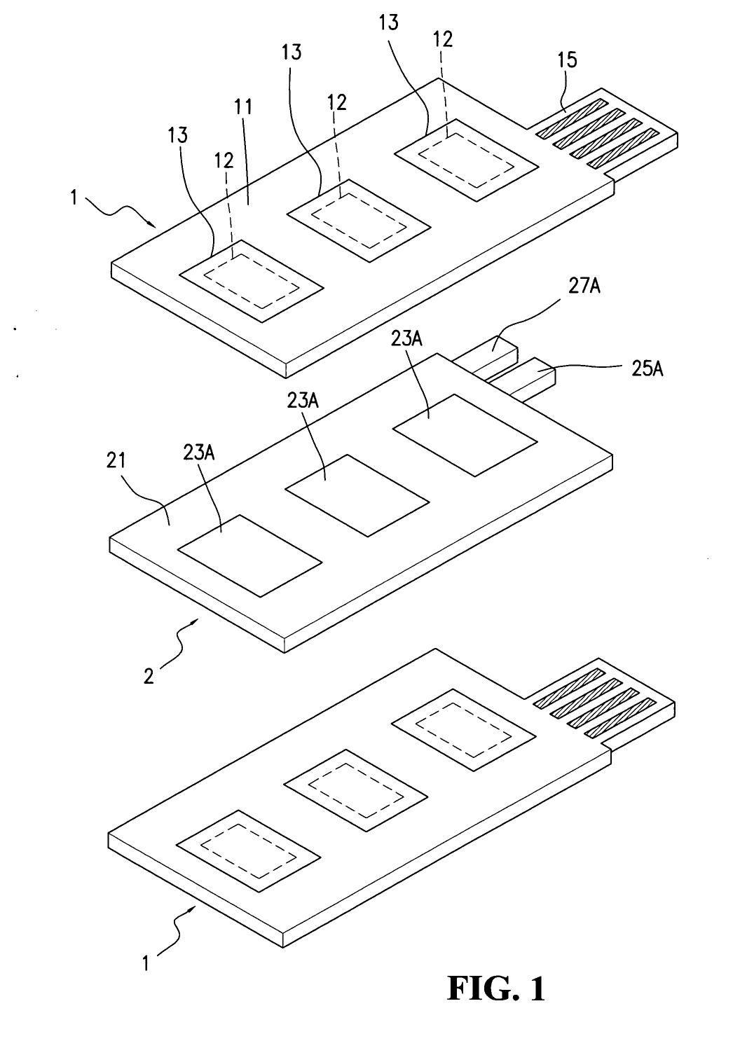

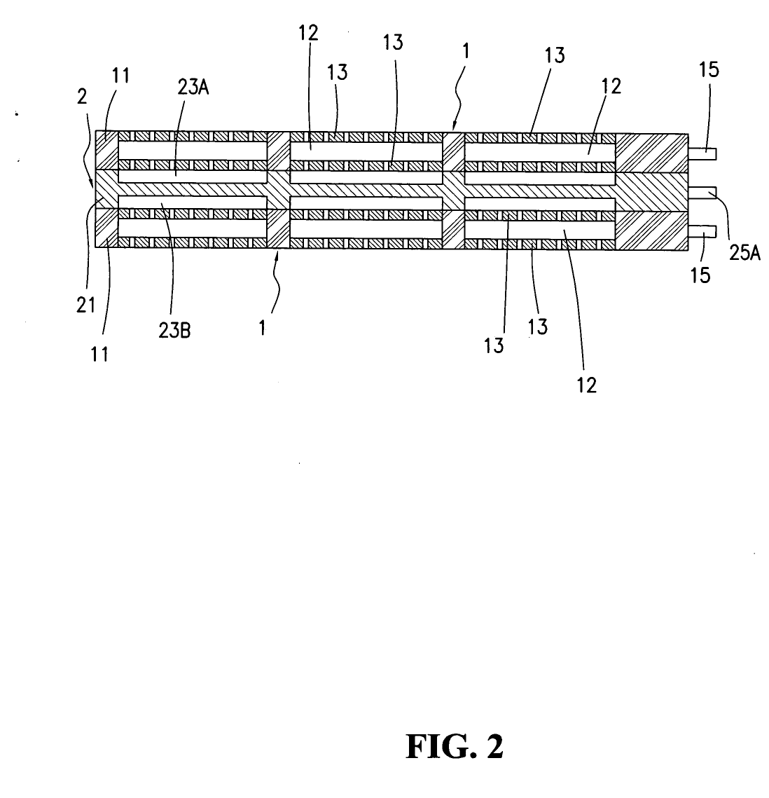

FIG. 1 is an exploded diagram of a fuel cell device having a two-sided fuel flow board according to one embodiment of the invention. FIG. 2 shows the cross-section view of FIG. 1. A fuel cell board 1 includes a substrate 11, plural of membrane electrolyte assemblies (MEAs) 12 disposed on local regions of the substrate 11, and current collection layers 13 separately formed on the upper and lower surfaces of the substrate 11. A two-sided fuel flow board 2 of the invention is sandwiched in between the top fuel cell board 1 and the bottom fuel cell board 1. As fuel inside the two-sided fuel flow board 2, such as liquid fuel of methanol solutions, and gas fuel of hydrogen, flow into the MEAs 12, the top and the bottom fuel cell boards 1 generate currents individually. Through the serial and parallel connections of the current collection layers 13 on each of the fuel cell boards 1, the resultant voltages are electrically coupled to signal port 15 for external power supply.

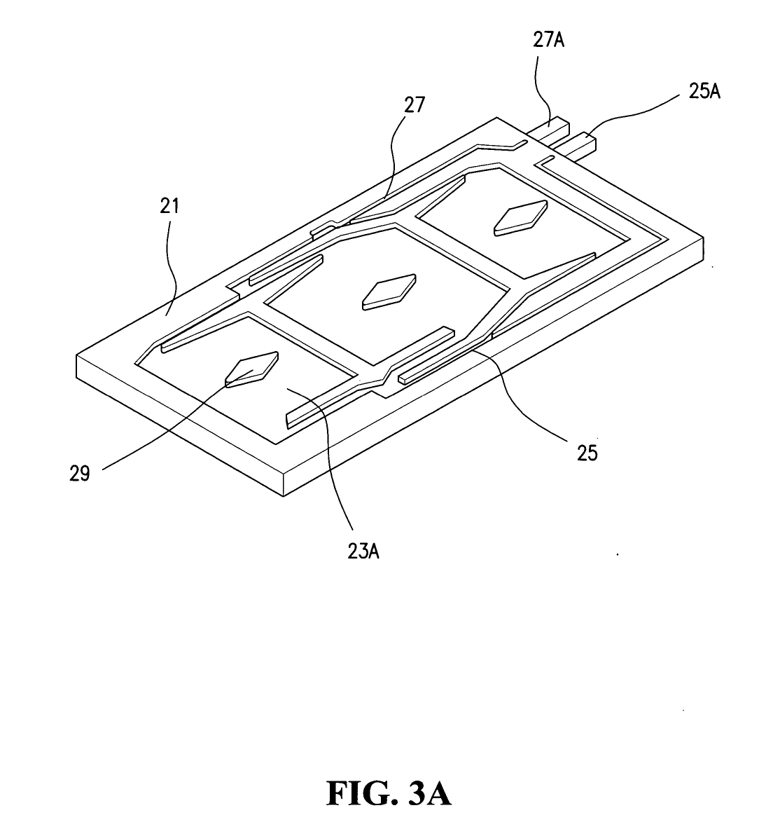

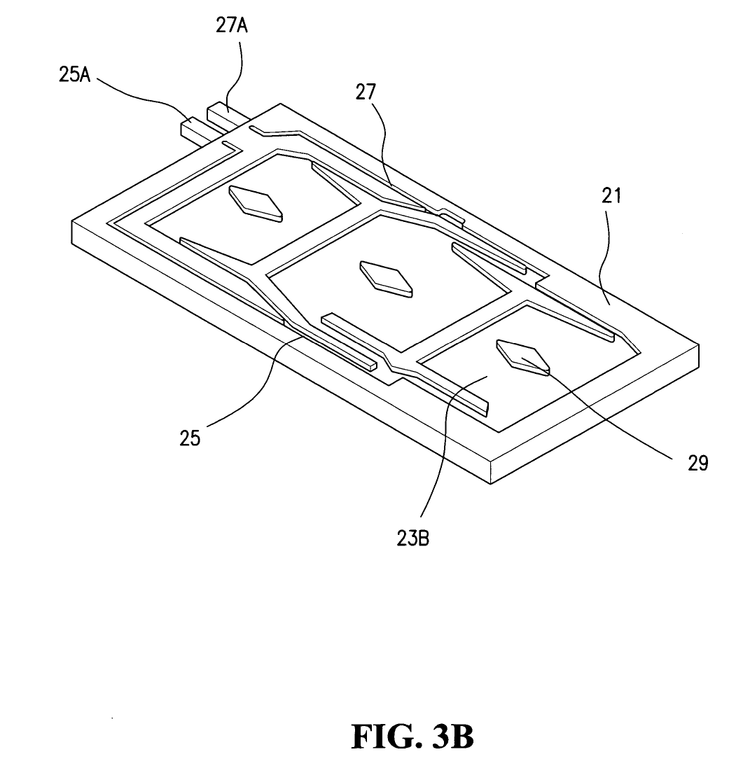

FIG. 3A illustrates a view of the upper surface of a two-sided fuel flow board according to one embodiment of the invention, and FIG. 3B illustrates a view of the lower surface of a two-sided fuel flow board according to one embodiment of the invention. As shown in FIG. 3A and FIG. 3B, the fuel flow board 2 is a piece of plate 21, which may be a metallic substrate, a plastic substrate, and so on. At least one top concave portion 23A and at least one bottom concave portion 23B are disposed on the upper surface and the lower surface of the plate 21, respectively, and are positioned corresponding to each MEA 12 of the fuel cell board 1. In addition, each concave portion 23A and 23B on the upper surface and the lower surface of the plate 21 individually extend to form injection flow channels 25 and exhaust flow channels 27 that has an inlet 25A and an outlet 27A at the end thereof on the side of the plate 21. The inlet 25A and the outlet 27A can be disposed on the same side of the plate 21. Moreover, the inlet 25A and the outlet 27A can be disposed on the same side of the signal port 15. Consequently, it is convenient to inject or exhaust fuel, and couple electrical connections at the same time.

The injection flow channels 25 and the exhaust flow channels 27 are disposed separately below and above each of the concave portions 23A and 23B. The structures of the injection flow channels 25 and the exhaust flow channels 27 can be designed to be specially deployed and have suitable sizes of cross-sections, such that fuel from the inlet 25A uniformly flow into each concave portion 23A and 23B among the injection flow channels 25. Besides, products formed during electrochemical reaction of the two fuel cell boards 1 are drained out from the outlet 27A through each of the concave portions 23A, 23B and the exhaust flow channels 27.

A support member 29 extended upward from the bottom of each concave portion 23A and 23B, for example, from the center, is almost as high as the side of the concave portion 23A and 23B. The height of the support member 29 can be the same as that of the side of the concave portion 23A and 23B, or be slightly higher than that of the side of the concave portion 23A and 23B. Each support member 29 supports the each corresponding MEA 12 while the substrate 11 of the fuel cell board 1 is stuck on the surface of the fuel flow board 2, so as to prevent the MEA 12 from swelling out of the concave portion 23A and 23B due to heat generated by electrochemical reaction of the MEAs 12, and from decreasing its performance.

The two-sided fuel flow board of the present invention has some advantages and dominant improvements, which are summarized as follows:
1. It is feasible to manufacture a small-sized fuel cell device using the two-sided fuel flow board that supplies fuel by both the upper and the lower surfaces thereof; and
2. The fuel cell board is securely stuck on the surface of the two-sided fuel flow board because of the support of each support member thereon.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A two-sided fuel flow board structure, said structure comprising:
a plate; and
at least one a top concave portion and at least one bottom concave portion separately formed on an upper surface and a lower surface of said plate, wherein each of the top and the bottom concave portions is disposed corresponding to each membrane electrode assembly of a fuel cell board.

2. The two-sided fuel flow board structure of claim 1, further comprising:
at least one injection flow channel formed on the upper surface and the lower surface of said plate, and separately connected to each of the top and the bottom concave portions; and
at least one exhaust flow channel formed on the upper surface and the lower surface of said plate, and separately connected to each of the top and the bottom concave portions.

3. The two-sided fuel flow board structure of claim 2, wherein said injection flow channels and said exhaust flow channels are deployed below and above each of the top and the bottom concave portions, respectively.

4. The two-sided fuel flow board structure of claim 2, further comprising:
an inlet disposed on a side of said plate, and connected to an end of said injection flow channels; and
an outlet disposed on a side of said plate, and connected to an end of said exhaust flow channels.

5. The two-sided fuel flow board structure of claim 1, further comprising at least one support member disposed inside each of the top and the bottom concave portions, wherein said support member is almost as high as a side of the top and the bottom concave portions, or is higher than a side of the top and the bottom concave portions.

6. The two-sided fuel flow board structure of claim 5, wherein said support member is disposed in a center of each of the top and the bottom concave portions.

7. The two-sided fuel flow board structure of claim 5, wherein a plurality of said support members are separately disposed in a right upper region, a right lower region, a left upper region, and a left lower region near a center of each of the top and the bottom concave portions.

8. The two-sided fuel flow board structure of claim 4, wherein said inlet and said outlet are disposed on the same side of said plate.

9. The two-sided fuel flow board structure of claim 1, where the amount of said top concave portions is more than one.

10. The two-sided fuel flow board structure of claim 1, where the amount of said bottom concave portions is more than one.
